(19) United States
(12) Patent Application Publication
(10) Pub. No.: US 2015/0102870 A1
(43) Pub. Date: Apr. 16, 2015

(54) DIRECTIONAL COUPLER ARRANGEMENT AND METHOD

(71) Applicant: Huawei Technologies Co., Ltd., Shenzhen (CN)

(72) Inventors: Guoyu SU, Shenzhen (CN); Fabio MORGIA, Milan (IT); Franco MARCONI, Milan (IT)

(21) Appl. No.: 14/570,788

(22) Filed: Dec. 15, 2014

Related U.S. Application Data
(63) Continuation of application No. PCT/EP2012/061578, filed on Jun. 18, 2012.

(51) Int. Cl. H01P 5/18; H01P 11/00

(52) U.S. Cl. CPC H01P 5/181; H01P 5/184; H01P 11/002; H01P 11/003
USPC 333/113; 333/116; 29/600

(57) ABSTRACT

A directional coupler arrangement comprising an air waveguide and a coupler port having a coupler line arranged inside the air waveguide. A method for producing a directional coupler arrangement comprising forming an air waveguide and forming a coupler port having a coupler line arranged inside the air waveguide is also disclosed.

### CROSS-REFERENCE TO RELATED APPLICATIONS

This application is a continuation of International Patent Application No. PCT/EP2012/061578, filed on Jun. 18, 2012, which is hereby incorporated by reference in its entirety.

### TECHNICAL FIELD

The present invention relates generally to radio technology and specifically to directional coupler arrangements for waveguides. Even more specifically, the invention relates to a directional coupler arrangement where coupling to an air waveguide is within the air waveguide transition.

### BACKGROUND OF THE INVENTION

Directional couplers (DCs) are passive devices used in the field of radio technology. They couple a defined amount of the electromagnetic power in a transmission line to another port where it can be used in another circuit. A feature of directional couplers is that they only couple power flowing in one direction. Power entering the output port is not coupled. Directional couplers are most frequently constructed from two coupled transmission lines set close enough together such that energy passing through one is coupled to the other. This technique is favoured due to the microwave frequencies the devices are commonly employed with. The two transmission lines are coupled together by a gap. When applying directional couplers together with air waveguides in radio transmission devices, manufacturing tolerances limit the performance of the transition between the electrical interface and the air interface. In particular, manufacturing tolerances have a negative influence on operational bandwidth, directivity, and impedance matching of the directional coupler.

### SUMMARY OF THE INVENTION

The invention provides an interface to an air waveguide with a directional coupler which interface is robust against manufacturing tolerances.

This object is achieved by the features of the independent claims. Further implementation forms are apparent from the dependent claims, the description and the figures.

The invention is based on the finding of the inventors that placing the coupler line of a directional coupler inside the air waveguide makes the interface to the air waveguide more robust against manufacturing tolerances and improves its behavior with respect to insertion loss, directivity, operational bandwidth and impedance matching.

In order to describe the invention in detail, the following terms, abbreviations and notations will be used:
DC: directional coupler.
Port 1: first port of a directional coupler, e.g. the input port where the power is applied.
Port 2: second port of a directional coupler, e.g. the output port or the transmitted port where the power from “Port 1” is output.
Port 3: third port of a directional coupler, e.g. the coupled port where a portion of the power applied to “Port 1” appears.
Port 4: fourth port of a directional coupler, e.g. the isolated port where a portion of the power applied to “Port 2” is coupled to. The isolated port is usually terminated with a matched load.
PCB: printed circuit board.

According to a first aspect, the invention relates to a directional coupler arrangement, comprising: an air waveguide; and a coupler port having a first coupler line; wherein the first coupler line is arranged inside the air waveguide.

By placing the coupler line inside the waveguide, the directional coupler arrangement exhibits lower insertion loss than a directional coupler having the coupler line placed outside the waveguide.

By placing the coupler line inside the waveguide, the directional coupler arrangement requires less space on a printed circuit board compared to an arrangement where the coupler line is arranged externally.

In a first possible implementation form of the directional coupler arrangement according to the first aspect, the first coupler line comprises a microstrip line.

By placing the coupler line inside the waveguide, the directional coupler arrangement is insensitive to manufacturing tolerances of the printed circuit board (PCB) on which the microstrip lines are mounted. The amount of energy coupled to the coupler line does not depend on a gap between two microstrip lines. Therefore, the directional coupler arrangement does not require a space consuming double microstrip line. Instead, a single microstrip line is sufficient saving space on the PCB.

In a second possible implementation form of the directional coupler arrangement according to the first aspect as such or according to the first implementation form of the first aspect, the first coupler line is unshielded located inside the air waveguide spaced from the conductive coating of the air waveguide, that is, without touching a coating of the air waveguide.

When no shielding has to be brought into the air waveguide, the design of the air waveguide becomes less complex. When fabrication becomes easier, fewer manufacturing tolerances have to be observed.

In a third possible implementation form of the directional coupler arrangement according to the first aspect as such or according to any of the preceding implementation forms of the first aspect, the directional coupler arrangement further comprises a second coupler port having a second coupler line.

While the first coupler line is used for coupling energy from the air waveguide, the second coupler line may be used for coupling energy into the air waveguide or vice versa.

In a fourth possible implementation form of the directional coupler arrangement according to the third implementation form of the first aspect, the second coupler line comprises a second microstrip line.

The directional coupler arrangement may be used for the transition of electrical energy transported on the second microstrip line to electromagnetic energy transported in the air waveguide.

In a fifth possible implementation form of the directional coupler arrangement according to the fourth implementation form of the first aspect, the second microstrip line comprises a pitch arranged inside the air waveguide.

The pitch forms the transition point where electrical energy transported on the second microstrip line is coupled to electromagnetic energy transported in the air waveguide. A further transition point where the electromagnetic energy transported in the air waveguide is re-coupled to electrical energy transported on the (first) microstrip line is formed by the coupler line placed inside the air waveguide. The air waveguide forms a kind of shielding for the energy transition points. Therefore, energy losses are reduced compared to a common directional coupler where the energy transition points are not shielded by an air waveguide. This shielding facilitates manufacturing of the directional coupler arrangement and improves manufacturing tolerances.

In a sixth possible implementation form of the directional coupler arrangement according to the fifth implementation form of the first aspect, the pitch is rectangular and a width of the first coupler line is smaller than a width of the pitch.

A rectangular pitch is matched to a rectangular formed air waveguide and supports improved transition between the electric energy carried by the second microstrip line to the electromagnetic energy transported in the air waveguide.

The second microstrip line represents the input port of the directional coupler, the air waveguide represents the output port of the directional coupler and the (first) microstrip line represents the coupled port of the directional coupler. When the width of the first coupler line is smaller than the width of the pitch, a higher amount of energy is transmitted from the input port to the output port than from the output port to the coupled port. The performance of the directional coupler is improved.

In a seventh possible implementation form of the directional coupler arrangement according to the first aspect as such or according to any of the preceding implementation forms of the first aspect, the directional coupler arrangement comprises an isolated port connected to the first coupler line.

A matched load may be coupled to the isolated port improving the accuracy of the directional coupler arrangement. With an isolated port coupled to a matched load the directional coupler arrangement exhibits good matching and the coupler performance is insensitive to the externally applied load.

In an eighth possible implementation form of the directional coupler arrangement according to any of the third to the seventh implementation forms of the first aspect, the first coupler line and the second coupler line are arranged on a common plane substantially perpendicular or perpendicular to a main direction of the air waveguide.

By arranging the coupler line and the second coupler line on a common plane, manufacturing of the directional coupler arrangement becomes easy. A single printed circuit board may be used for implementation of the directional coupler arrangement.

In a ninth possible implementation form of the directional coupler arrangement according to the eighth implementation form of the first aspect, the first coupler line is U-shaped on the common plane.

By using a symmetrical U-shape, the coupled port and isolated port of the directional coupler arrangement are positioned at the same side of the air waveguide which facilitates external connection of the ports.

In a tenth possible implementation form of the directional coupler arrangement according to the eighth implementation form of the first aspect, the first coupler line is L-shaped on the common plane.

By using the L-shape, the coupled port and isolated port of the directional coupler arrangement are located at different sides of the air waveguide. A first side of the air waveguide may be assigned to the coupling equipment while a second side of the air waveguide may be assigned to the isolation equipment, i.e. electrical elements implementing the matched load. Coupling equipment and isolation equipment may be spaced apart from one another so as to allow a higher precision in implementing the matched load and thus improved directivity of the directional coupler arrangement.

In an eleventh possible implementation form of the directional coupler arrangement according to the eighth implementation form of the first aspect, the coupler line is I-shaped on the common plane. It may therefore extend linearly across the common plane.

By using an I-shape for the coupler line the coupler line is easy to produce as no further manufacturing steps for shaping the coupler line are required thereby improving the manufacturing tolerances.

In a twelfth possible implementation form of the directional coupler arrangement according to any of the eighth to the eleventh implementation forms of the first aspect, the coupler line and the second coupler line are arranged on a substrate layer forming the common plane.

When the first coupler line and the second coupler line are arranged on a common substrate layer, the directional coupler arrangement may be realized on a common printed circuit board or on a single chip

According to a second aspect, the invention relates to a method for producing a directional coupler arrangement, comprising: forming an air waveguide; and forming a coupler port having a first coupler line; wherein the first coupler line is arranged inside the air waveguide.

By arranging the first coupler line inside the waveguide, the directional coupler arrangement exhibits lower insertion loss than a directional coupler having the coupler line placed outside the waveguide.

By arranging the coupler line inside the waveguide, the directional coupler arrangement requires less space on a printed circuit board compared to an arrangement where the coupler line is arranged externally.

In a first possible implementation form of the method according to the second aspect, the forming the coupler port comprises: forming the first coupler line as a microstrip line; and placing the first coupler line unshielded inside the air waveguide without touching a coating of the air waveguide.

By placing the coupler line inside the waveguide, the directional coupler arrangement is insensitive to manufacturing tolerances of the printed circuit board (PCB) on which the microstrip lines are mounted. The amount of energy coupled to the coupler line does not depend on a gap between two microstrip lines. Therefore, the directional coupler arrangement does not require a space consuming double microstrip line, a single microstrip line is sufficient saving space on the PCB. When no shielding has to be brought into the air waveguide, the design of the air waveguide becomes less complex. When fabrication becomes easier, less manufacturing tolerances have to be observed.

In a second possible implementation form of the method according to the second aspect as such or according to the first implementation form of the second aspect, the method further comprises: forming a second coupler port having a second coupler line.

While the coupler line is used for coupling energy from the air waveguide, the second coupler line may be used for coupling energy into the air waveguide or vice versa.

In a third possible implementation form of the method according to the second implementation form of the second aspect, the forming the second coupler port comprises: forming the second coupler line as a second microstrip line having a pitch; and arranging the pitch inside the air waveguide.

The pitch forms the transition point where electric energy transported on the second microstrip line is coupled to electromagnetic energy transported in the air waveguide. A further transition point where the electromagnetic energy transported in the air waveguide is re-coupled to electric energy transported on the (first) microstrip line is formed by the coupler line placed inside the air waveguide. The air waveguide forms a kind of shielding for the energy transition points. Therefore, energy losses are reduced compared to a common directional coupler where the energy transition points are not shielded by an air waveguide. This shielding facilitates manufacturing of the directional coupler arrangement and improves manufacturing tolerances.

In a fourth possible implementation form of the method according to the third implementation form of the second aspect, the method further comprises: forming the coupler line and the pitch on a substrate layer; and arranging the substrate layer inside the air waveguide.

When the first coupler line and the second coupler line with the pitch are arranged on a common substrate layer, the directional coupler arrangement may be realized on a common printed circuit board or on a single chip

### BRIEF DESCRIPTION OF THE DRAWINGS

Further illustrative embodiments of the invention will be described with respect to the following figures, in which:

FIG. 1 shows a cross-sectional representation of a directional coupler arrangement according to an implementation form;

FIG. 2 shows a three-dimensional representation of the directional coupler arrangement depicted in FIG. 1 according to an implementation form;

FIG. 3 shows a cross-sectional representation of a directional coupler arrangement according to an implementation form;

FIG. 4 shows a three-dimensional representation of the directional coupler arrangement depicted in FIG. 3 according to an implementation form;

FIG. 5 shows a cross-sectional representation of a directional coupler arrangement according to an implementation form;

FIG. 6 shows a three-dimensional representation of the directional coupler arrangement depicted in FIG. 5 according to an implementation form; and

FIG. 7 shows a schematic diagram of a method for producing a directional coupler arrangement according to an implementation form.

### DETAILED DESCRIPTION OF EMBODIMENTS OF THE INVENTION

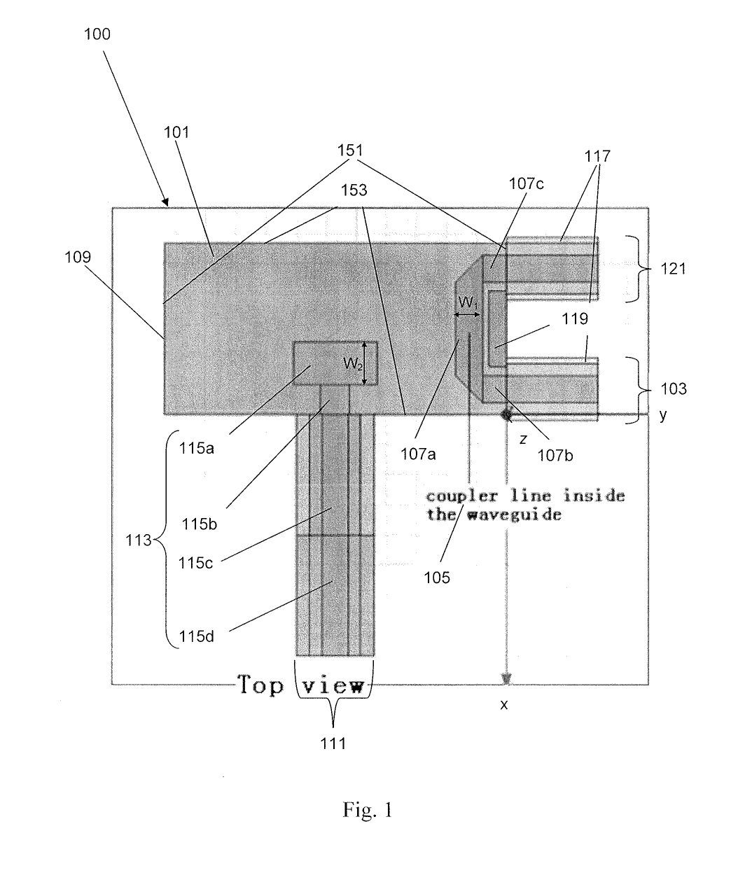

FIG. 1 shows a cross-sectional representation of a directional coupler arrangement 100 according to an implementation form. The directional coupler arrangement 100 comprises an air waveguide 101 and a coupler port 103. The coupler port 103 comprises a coupler line 105 which is arranged inside the air waveguide 101. The air waveguide 101 comprises a hollow body with metallic coating 109 and rectangular cross-section and is configured to guide electromagnetic waves within its body by reflection of the waves at the metallic coating 109. The cross-section may also have other geometrical forms, e.g. as square or circle, and the cross-section may vary in the direction z in which waves are guided by the air waveguide 101. The coupler line 105 is placed inside the air waveguide 101 and thereby in direct contact with electromagnetic waves traveling through the air waveguide 101. These electromagnetic waves induce a voltage in the coupler line 105 by electromagnetic induction such that a specific amount of the power of the electromagnetic waves traveling through the air waveguide 101 is induced in the coupler line 105 and can be measured at the coupler port 103. The coupler port 103 may also be used for generating electromagnetic waves inside the air waveguide 101 by using the inverse inductive effect.

The coupler line 105 comprises a microstrip line 107a, 107b, 107c which comprises a first part 107a, a second part 107b and a third part 107c. All three parts 107a, 107b, 107c of the microstrip line have a thickness W₁, shown as being measured in place in the y direction The amount of power induced in the microstrip line depends on that thickness W₁. The microstrip line 107a, 107b, 107c and so the coupler line 105 is U-formed, wherein the first part 107a of the microstrip line forms the base line of the U and the second and third parts 107b and 107c form the two side lines of the U. The microstrip line is placed in the air waveguide 101 in such a manner that the base line 107a of the U is mounted inside the air waveguide 101 without touching its coating 109 and that the two side lines 107b and 107c of the U are mounted at a smaller wall 151 of the air waveguide 101 which is represented in FIG. 1 by the smaller side of the air waveguide's rectangular cross-section. At each fixing point where the two side lines 107b and 107 are fixed to the smaller wall 151 of the air waveguide 101, a hole is formed e.g by cutting in the coating 109 of the air waveguide 101 such that the coupler line 105 inside the air waveguide is isolated from the coating 109 for not producing a short. While FIG. 1 depicts a mounting of the side lines 107b and 107c of the U-formed coupler line 105 at a smaller wall 151 of the air waveguide 101, the side lines 107b and 107c may also be attached to a longer wall 153 of the air waveguide 101 which is represented in FIG. 1 by the longer side of the air waveguide's rectangular cross-section. In FIG. 1, the U-formed coupler line 105 is centrally attached to the smaller wall 151 of the air waveguide 101. The coupler line 105 may also be attached non-centrally to one wall, i.e. a smaller wall 151 or a longer wall 153, of the air waveguide 101. The U-form of the coupler line 105 may be produced by folding a microstrip line two times by about 90 degrees such that a trapezoid forms the base line 107a of the U and two rectangles form the two side lines 107b and 107c of the U. The coupler line 105 has a thickness of W₁. In FIG. 1, the base line 107a has the thickness W₁, but the side lines 107b and 107c may have the same thickness W₁ or they may have a different thickness (not shown).

The coupler port 103 comprises a shielding 117 surrounding an inner line of the coupler port 103 which inner line is formed by the second part 107b of the microstrip line 107a, 107b, 107c. The shielding 117 of the coupler port 103 is connected to the metallic coating 109 of the air waveguide 101 and does not shield the coupler line 105 inside the air waveguide 101 such that the coupler line 105 is unshielded placed inside the air waveguide 101 without touching the coating 109 of the air waveguide 101.

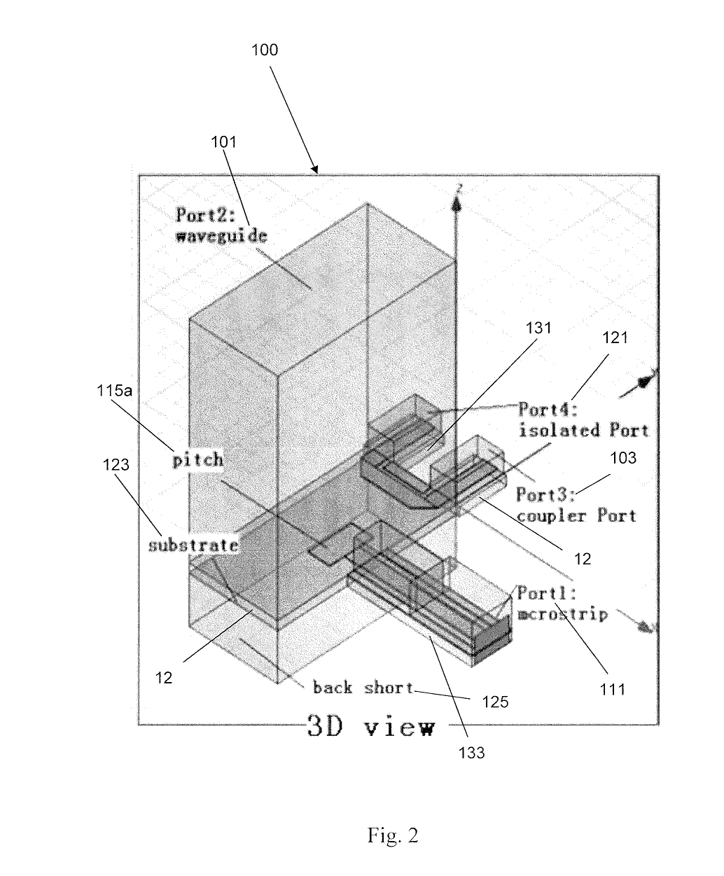

The directional coupler arrangement 100 further comprises an isolated port 121 connected to the coupler line 105. The isolated port 121 comprises a shielding 117 surrounding an inner line of the isolated port 121 which inner line is formed by the third part 107c of the microstrip line 107a, 107b, 107c. The shielding 117 of the isolated port 121 is connected to the metallic coating 109 of the air waveguide 101. The shielding 117 of the isolated port 121 and the shielding 117 of the coupler port 103 are formed as small waveguides with rectangular cross-section, as can be seen in FIG. 2 illustrating a three-dimensional representation of the directional coupler arrangement 100. Both shieldings 117 are attached to the air waveguide 101 by a conducting connection. An inner connector 119 is placed inside the air waveguide 101 and connects the shieldings 117 of coupler port 103 and isolated port 121. The inner connector 119 has a higher thickness than the shieldings 117 of both ports 103, 121 and provides for a good connection between both shieldings 117.

The directional coupler arrangement 100 further comprises a second coupler port 111 having a second coupler line 113. The second coupler line 113 comprises a second microstrip line 115a, 115b, 115c, 115d having a first part 115a, a second part 115b, a third part 115c and a fourth part 115d. The second, third and fourth parts 115b, 115c, 115d of the second microstrip line have a same thickness which is smaller than a thickness W₂ of the first part 115a. The first part 115a is a pitch of the second microstrip line. The amount of power induced from the second microstrip line 115a, 115b, 115c, 115d into the air waveguide 101 or vice versa depends on the size and the thickness W₂. of the pitch 115a. The thickness, W₂, may as shown by measured in plane in the x direction.

The second microstrip line 115a, 115b, 115c, 115d and so the second coupler line 113 is T-shaped, where the wherein the first part 115a of the second microstrip line forms the upper line of the T and the second, third and fourth parts 115b, 115c, 115d which are arranged on a common line forming the base line of the T.

The second microstrip line is placed in the air waveguide 101 in such a manner that the upper line 115a of the T which is the pitch 115a is mounted inside the air waveguide 101 without touching its coating 109 and that the base line of the T is mounted at the longer wall 153 of the air waveguide 101 which is represented in FIG. 1 by the longer side of the air waveguide's rectangular cross-section. The second microstrip line is not in contact with the coating 109 of the air waveguide 101. The connection of the microstrip line between inside and outside of the air waveguide 101 is between the second part 115b which is still inside the air waveguide and the third part 115c which is outside the air waveguide 101. At the connection point a hole is cut in the coating 109 of the air waveguide 101 such that the second coupler line 113 inside the air waveguide 101 is isolated from the coating 109 for not producing a short. While FIG. 1 depicts a mounting of the second coupler line 113 at a longer wall 153 of the air waveguide 101, the second coupler line 113 may also be attached to a shorter wall 151 of the air waveguide 101 which is represented in FIG. 1 by the shorter side of the air waveguide's rectangular cross-section. In FIG. 1, the T-shaped second coupler line 113 is centrally attached to the longer wall 153 of the air waveguide 101. The second coupler line 113 may also be attached non-centrally to one wall, i.e. a smaller wall 151 or a longer wall 153, of the air waveguide 101. In an embodiment (not shown) both the coupler line 105 and the second coupler line 113 are attached at the same wall of the air waveguide 101, which may be the shorter wall 151 or the longer wall 153. The T-form of the second coupler line 113 may be produced by cutting a microstrip line from a piece of metal. In FIG. 1, the pitch 115a is rectangular formed. A width W₁ of the coupler line 105 is smaller than a width W₂ of the pitch 115a. The pitch 115a may also have another geometrical form, e.g. a square, a circle or an ellipsoid.

FIG. 2 shows a three-dimensional representation of the directional coupler arrangement 100 depicted in FIG. 1 according to an implementation form. In FIG. 2, a detailed representation of the coupler port (103) denoted as “Port 3”, the second coupler port 111 denoted as “Port 1” and the isolated port 121 denoted as “Port 4” is illustrated. The air waveguide 101 comprises a base opening and a top opening directed towards the z-axis. The base opening is a back short 125 while through the top opening electromagnetic waves traveling through the air waveguide 101 are emitted. The top opening thus represents the waveguide port or output port of the waveguide 101 denoted as “Port2” which emits electromagnetic waves in z-direction.

As directional couplers usually have four ports, “Port 1”, i.e. the second coupler port 111, may be seen as the input port where the power is applied. “Port 3”, i.e. the coupler port 103, may be seen as the coupled port where a portion of the power applied to “Port 1” appears. “Port 2”, i.e. the output port of the air waveguide 101, may be seen as the transmitted port where the power from “Port 1” is output. “Port 4”, i.e. the isolated port 121, may be seen as the isolated port, where a portion of the power applied to the transmitted port, “Port 2” is coupled to.

The isolated port “Port 4” is usually terminated with a matched load (not depicted in FIG. 2). This termination may be internal to the device and “Port 4” is not accessible to the user. Effectively, this results in a 3-port device. In an implementation form, the directional coupler arrangement is a 3-port device having an input port “Port 1”, a coupled port “Port 3” and a transmitted port “Port 2” which are accessible to the user and having an isolated port “Port 4” which is not accessible to the user. In an implementation form, the isolated port 121 is terminated with a matched load. In an implementation form, the directional coupler arrangement is a 4-port device having an input port “Port 1”, a coupled port “Port 3”, a transmitted port “Port 2” and an isolated port “Port 4” which are accessible to the user.

As can be seen from FIG. 2, the coupler line 105 and the second coupler line 113 are arranged on a common plane spanned by the axes x and y which plane is substantially perpendicular to a main emitting i.e. propagation direction z of the air waveguide 101. The common plane is formed by a substrate layer 123 on which the coupler line 105 and the second coupler line 113 are mounted. A main section 127 of the substrate layer 123 is rectangular formed and is placed inside the air waveguide 101. First 129, second 131 and third 133 subsections of the substrate layer 123 are rectangular formed and are placed outside the air waveguide 101. The second part 107b of the microstrip line 107a, 107b, 107c is attached together with the shielding 117 of the coupler port 103 on the first subsection 129 of the substrate layer 123 forming the coupler port 103. The third part 107c of the microstrip line 107a, 107b, 107c is attached together with the shielding 117 of the isolated port 121 on the second subsection 131 of the substrate layer 123 forming the isolated port 121. The third 115c and fourth 115d parts of the second microstrip line 115a, 115b, 115c, 115d are attached together with the shielding 117 of the second coupler port 111 on the third subsection 133 of the substrate layer 123 forming the second coupler port 111. The first 115a and second 115b parts of the second microstrip line 115a, 115b, 115c, 115d are attached on the main section 127 of the substrate layer 123. A shielding 117 around the fourth 115d part of the second microstrip line 115a, 115b, 115c, 115d is larger than a shielding 117 around the third 115c part of the second microstrip line 115a, 115b, 115c, 115d.

In an implementation form, the main section 127, the first 129, the second 131 and the third 133 subsections of the substrate layer 123 are formed on a common printed circuit board (PCB).

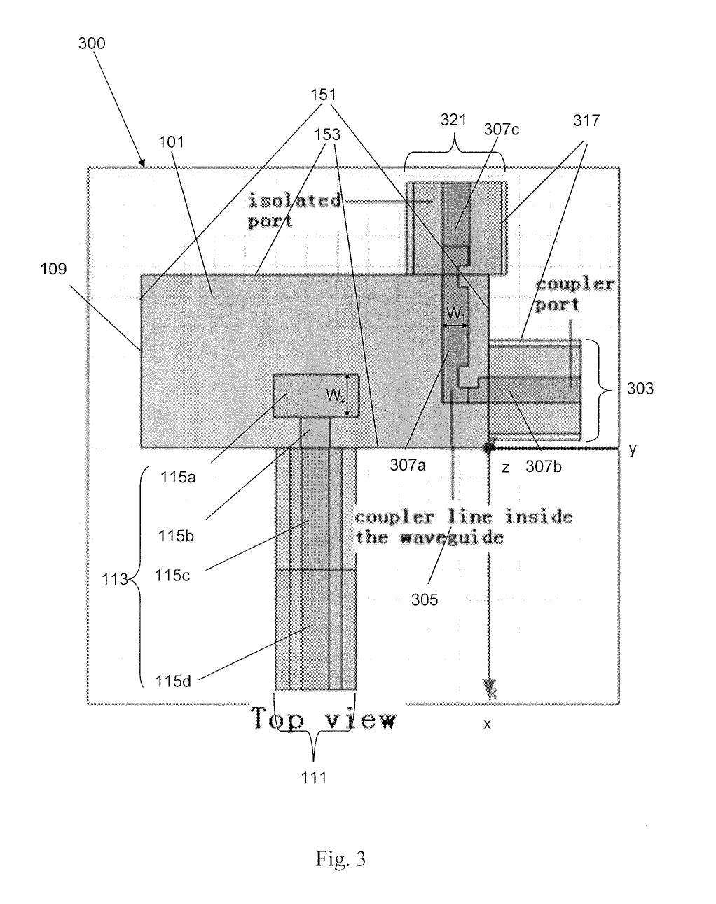

FIG. 3 shows a cross-sectional representation of a directional coupler arrangement 300 according to an implementation form. The directional coupler arrangement 300 comprises an air waveguide 101 and a coupler port 303. The coupler port 303 comprises a coupler line 305 which is arranged inside the air waveguide 101. The air waveguide 101 corresponds to the air waveguide 101 as described with respect to FIGS. 1 and 2. The coupler line 305 is placed inside the air waveguide 101 and thereby in direct contact with electromagnetic waves traveling through the air waveguide 101. These electromagnetic waves induce a voltage in the coupler line 305 by electromagnetic induction such that a specific amount of the power of the electromagnetic waves traveling through the air waveguide 101 is induced in the coupler line 305 and can be measured at the coupler port 303. The coupler port 303 may also be used for generating electromagnetic waves inside the air waveguide 101 by using the inverse inductive effect.

The coupler line 305 comprises a microstrip line 307a, 307b, 307c which comprises a first part 307a, a second part 307b and a third part 307c. All three parts 307a, 307b, 307c of the microstrip line have a thickness W₁. The amount of power induced in the microstrip line depends on that thickness W₁. The microstrip line 307a, 307b, 307c and so the coupler line 305 is L-shaped, wherein the first part 307a and the third part 307c of the microstrip line form the longer line of the L and the second part 307b forms the shorter line of the L. The microstrip line is placed in the air waveguide 101 in such a manner that the first part 307a is mounted inside the air waveguide 101 without touching its coating 109 and that the second and third parts 307b and 307c are mounted at two neighboring walls, a smaller one 151 and a longer one 153 of the air waveguide 101. The smaller wall 151 is represented in FIG. 3 by the smaller side of the air waveguide's rectangular cross-section and the longer wall 153 is represented in FIG. 3 by the longer side of the air waveguide's rectangular cross-section.

At each fixing point where the two lines 307b and 307c of the L are fixed to the walls 151 and 153 of the air waveguide 101, a hole is cut in the coating 109 of the air waveguide 101 such that the coupler line 305 inside the air waveguide 101 is isolated from the coating 109 for not producing a short. In FIG. 3, the second part 307b of the microstrip line is attached at a lower part of the smaller wall 151, i.e. spaced from a longer wall 153. This second part 307b may also be centrally attached to the smaller wall 151 or attached at an upper part of the smaller wall 151. In FIG. 3, the third part 307c of the microstrip line is attached at a right part of the longer wall 153. This third part 307c may also be centrally attached to the longer wall 153 or attached at a left part of the longer wall 153. In FIG. 3, the second part 307b of the microstrip line is attached at the right wall 151. This second part 307b may also be attached to the left wall 151 such that the microstrip line is formed as a mirrored L. In FIG. 3, the third part 307c of the microstrip line is attached at the upper wall 153. This third part 307b may also be attached to the lower wall 153 such that the microstrip line is formed as a mirrored L.

The L-form of the coupler line 105 may be produced by folding a microstrip line by about 90 degrees such that the L is formed by two trapezoid forms (not depicted in FIG. 3) or by cutting a metal foil in the shape of an L or by forming a metal layer in the shape of an L. In FIG. 3, the coupler line 305 has a thickness of W₁. In a transition region from a first side of the L to the second side of the L, the thickness is smaller than W₁.

The coupler port 303 comprises a shielding 317 surrounding an inner line of the coupler port 303 which inner line is formed by the second part 307b of the microstrip line 307a, 307b, 307c. The shielding 317 of the coupler port 303 is connected to the metallic coating 109 of the air waveguide 101 and does not shield the coupler line 305 inside the air waveguide 101 such that the coupler line 105 is unshielded placed inside the air waveguide 101 without touching the coating 109 of the air waveguide 101.

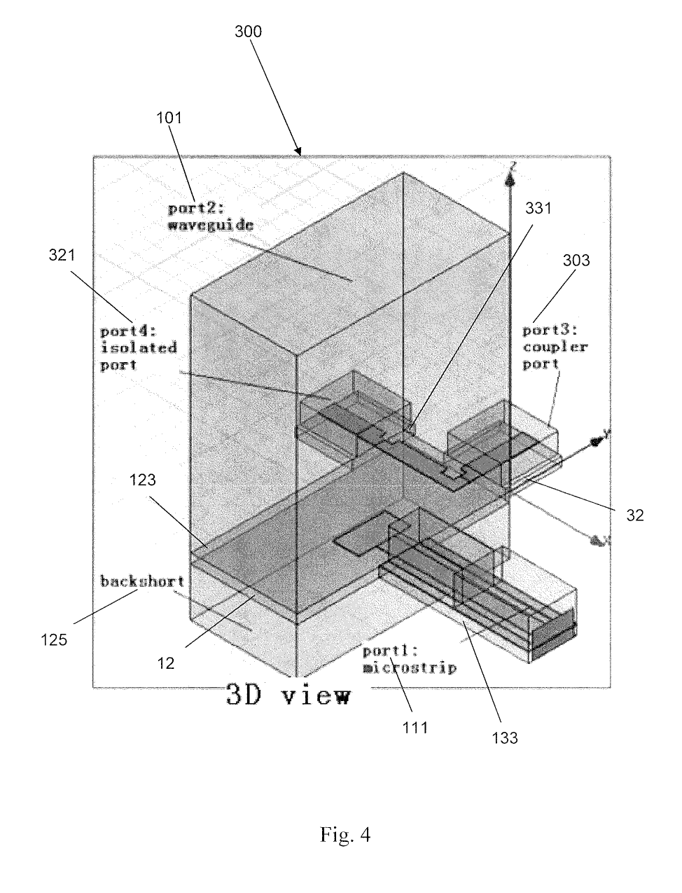

The directional coupler arrangement 300 further comprises an isolated port 321 connected to the coupler line 305. The isolated port 321 comprises a shielding 317 surrounding an inner line of the isolated port 321 which inner line is formed by the third part 307c of the microstrip line 307a, 307b, 307c. The shielding 317 of the isolated port 321 is connected to the metallic coating 109 of the air waveguide 101. The shielding 317 of the isolated port 321 and the shielding 317 of the coupler port 303 are formed as small waveguides with rectangular cross-section, as can be seen in FIG. 4 illustrating a three-dimensional representation of the directional coupler arrangement 300. Both shieldings 317 are attached to the air waveguide 101 by a conductive connection.

The directional coupler arrangement 300 further comprises a second coupler port 111 having a second coupler line 113 which correspond to the second coupler port with the second coupler line 113 as described with respect to FIGS. 1 and 2.

FIG. 4 shows a three-dimensional representation of the directional coupler arrangement 300 depicted in FIG. 3 according to an implementation form. In FIG. 4, a detailed representation of the coupler port 303 denoted as “Port 3”, the second coupler port 111 denoted as “Port 1” and the isolated port 321 denoted as “Port 4” is illustrated. The air waveguide 101 corresponds to the air waveguide 101 as described with respect to FIG. 2.

As can be seen from FIG. 4, the coupler line 305 and the second coupler line 113 are arranged on a common plane spanned by the axes x and y which plane is substantially perpendicular to a main emitting direction z of the air waveguide 101. The common plane is formed by a substrate layer 123 on which the coupler line 305 and the second coupler line 113 are formed, e.g. mounted. A main section 127 of the substrate layer 123 is rectangular formed and is placed inside the air waveguide 101. First 329, second 331 and third 133 subsections of the substrate layer 123 are rectangular formed and are placed outside the air waveguide 101. The second part 307b of the microstrip line 107a, 107b, 107c is attached together with the shielding 117 of the coupler port 303 on the first subsection 329 of the substrate layer 123 forming the coupler port 303. The third part 307c of the microstrip line 307a, 307b, 307c is attached together with the shielding 117 of the isolated port 321 on the second subsection 331 of the substrate layer 123 forming the isolated port 321. As per the description with respect to FIG. 2, the third 115c and fourth 115d parts of the second microstrip line 115a, 115b, 115c, 115d are attached together with the shielding 117 of the second coupler port 111 on the third subsection 133 of the substrate layer 123 forming the second coupler port 111. The first 115a and second 115b parts of the second microstrip line 115a, 115b, 115c, 115d are attached on the main section 127 of the substrate layer 123. A shielding 117 around the fourth 115d part of the second microstrip line 115a, 115b, 115c, 115d is larger than a shielding 117 around the third 115c part of the second microstrip line 115a, 115b, 115c, 115d.

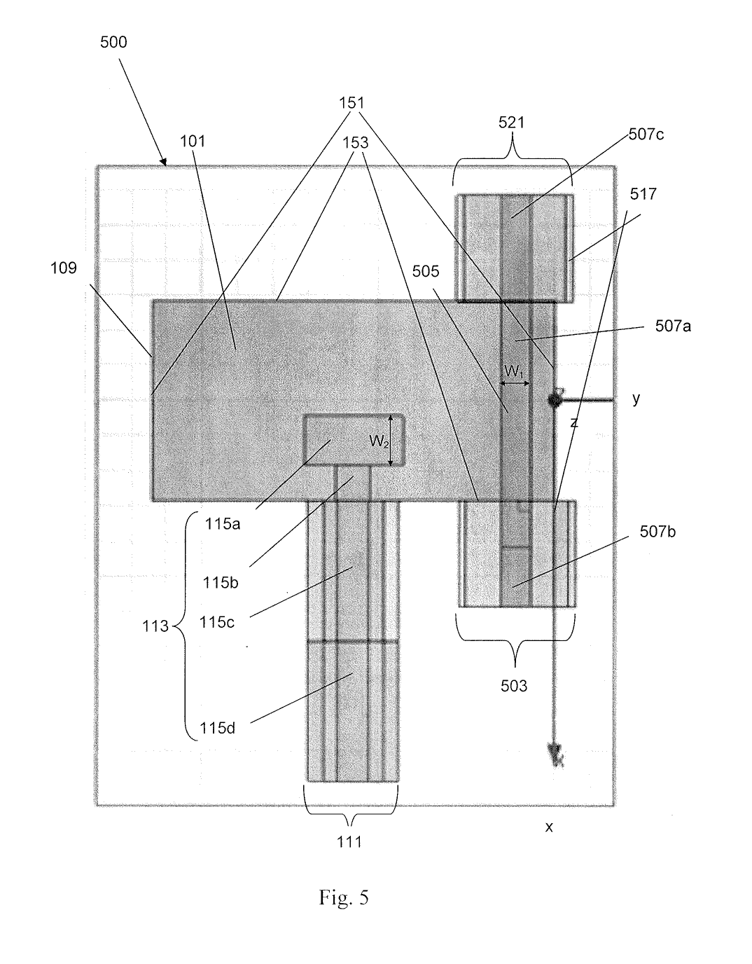

FIG. 5 shows a cross-sectional representation of a directional coupler arrangement 500 according to an implementation form. The directional coupler arrangement 500 comprises an air waveguide 101 and a coupler port 503. The coupler port 503 comprises a coupler line 505 which is arranged inside the air waveguide 101. The air waveguide 101 corresponds to the air waveguide 101 as described with respect to FIGS. 1 and 2. The coupler line 505 is placed inside the air waveguide 101 and thereby in direct contact with electromagnetic waves traveling through the air waveguide 101. These electromagnetic waves induce a voltage in the coupler line 505 by electromagnetic induction such that a specific amount of the power of the electromagnetic waves traveling through the air waveguide 101 is induced in the coupler line 505 and can be measured at the coupler port 503. The coupler port 503 may also be used for generating electromagnetic waves inside the air waveguide 101 by using the inverse inductive effect.

The coupler line 505 comprises a microstrip line 507a, 507b, 507c which comprises a first part 507a, a second part 507b and a third part 507c. All three parts 507a, 507b, 507c of the microstrip line have a thickness W₁. The amount of power induced in the microstrip line depends on that thickness W₁. The microstrip line 507a, 507b, 507c and so the coupler line 505 is I-shaped, wherein the second part 507b of the microstrip line forms the lower part of the I, the first part 507a of the microstrip line forms the middle part of the I and the third part 507c of the microstrip line forms the upper part of the I. The microstrip line is placed in the air waveguide 101 in such a manner that the middle part 507a is mounted inside the air waveguide 101 without touching its coating 109 and that the lower and upper parts 507b and 507c of the I are mounted at two opposite walls of the air waveguide 101, e.g. at the two longer walls 153 of the air waveguide 101 (as depicted in FIG. 5) or at the two smaller walls 151 of the air waveguide 101 (not depicted in FIG. 5). The smaller wall 151 is represented in FIG. 5 by the smaller side of the air waveguide's rectangular cross-section and the longer wall 153 is represented in FIG. 5 by the longer side of the air waveguide's rectangular cross-section.

At each fixing point where the lower and upper parts 507b and 507c of the I are fixed to the walls 153 of the air waveguide 101, a hole is formed e.g. by cutting in the coating 109 of the air waveguide 101 such that the coupler line 505 inside the air waveguide 101 is isolated from the coating 109 for not producing a short.

The I-shape of the coupler line 505 may be produced by cutting a metal foil in the shape of an I or by forming a metal layer in the shape of an I.

The coupler port 503 comprises a shielding 517 surrounding an inner line of the coupler port 503 which inner line is formed by the lower part 507b of the microstrip line 507a, 507b, 507c. The shielding 517 of the coupler port 503 is connected to the metallic coating 109 of the air waveguide 101 and does not shield the coupler line 505 inside the air waveguide 101 such that the coupler line 505 is unshielded placed inside the air waveguide 101 without touching the coating 109 of the air waveguide 101.

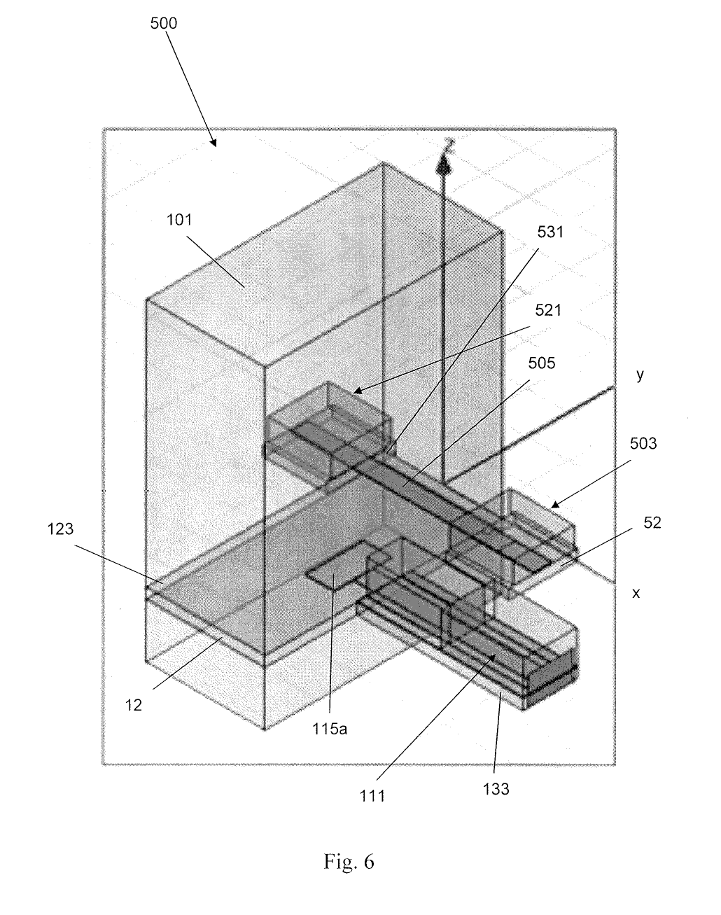

The directional coupler arrangement 500 further comprises an isolated port 521 connected to the coupler line 505. The isolated port 521 comprises a shielding 517 surrounding an inner line of the isolated port 521 which inner line is formed by the third part 507c of the microstrip line 507a, 507b, 507c. The shielding 517 of the isolated port 521 is connected to the metallic coating 109 of the air waveguide 101. The shielding 517 of the isolated port 521 and the shielding 517 of the coupler port 503 are formed as small waveguides with rectangular cross-section, as can be seen in FIG. 6 illustrating a three-dimensional representation of the directional coupler arrangement 500. Both shieldings 517 are attached to the air waveguide 101 by a conductive connection.

Both the coupler port 503 and the isolated port 521 are attached to the air waveguide 101 such that their shieldings 517 are not aligned with a side wall 151 of the air waveguide 101. According to an embodiment not depicted in FIG. 5, the shieldings 517 of coupler port 503 and/or isolated port 521 are aligned with the side wall 151 of the air waveguide 101.

The directional coupler arrangement 500 further comprises a second coupler port 111 having a second coupler line 113 which correspond to the second coupler port with the second coupler line 113 as described with respect to FIGS. 1 and 2.

FIG. 6 shows a three-dimensional representation of the directional coupler arrangement 500 depicted in FIG. 5 according to an implementation form. In FIG. 6, a detailed representation of the coupler port 503, the second coupler port 111 and the isolated port 321 is illustrated. The air waveguide 101 corresponds to the air waveguide 101 as described with respect to FIG. 2.

As can be seen from FIGS. 5 and 6, the coupler line 505 and the second coupler line 113 are arranged on a common plane spanned by the axes x and y which plane is substantially perpendicular to a main emitting direction z of the air waveguide 101. The common plane is formed by a substrate layer 123 on which the coupler line 505 and the second coupler line 113 are mounted. A main section 127 of the substrate layer 123 is rectangular formed and is placed inside the air waveguide 101. First 529, second 531 and third 133 subsections of the substrate layer 123 are rectangular formed and are placed outside the air waveguide 101. The second part 507b of the microstrip line 507a, 507b, 507c is attached together with the shielding 517 of the coupler port 503 on the first subsection 529 of the substrate layer 123 forming the coupler port 503. The third part 507c of the microstrip line 507a, 507b, 507c is attached together with the shielding 517 of the isolated port 521 on the second subsection 531 of the substrate layer 123 forming the isolated port 521. According to the description with respect to FIG. 2, the third 115c and fourth 115d parts of the second microstrip line 115a, 115b, 115c, 115d are attached together with the shielding 117 of the second coupler port 111 on the third subsection 133 of the substrate layer 123 forming the second coupler port 111. The first 115a and second 115b parts of the second microstrip line 115a, 115b, 115c, 115d are attached on the main section 127 of the substrate layer 123. A shielding 117 around the fourth 115d part of the second microstrip line 115a, 115b, 115c, 115d is larger than a shielding 117 around the third 115c part of the second microstrip line 115a, 115b, 115c, 115d.

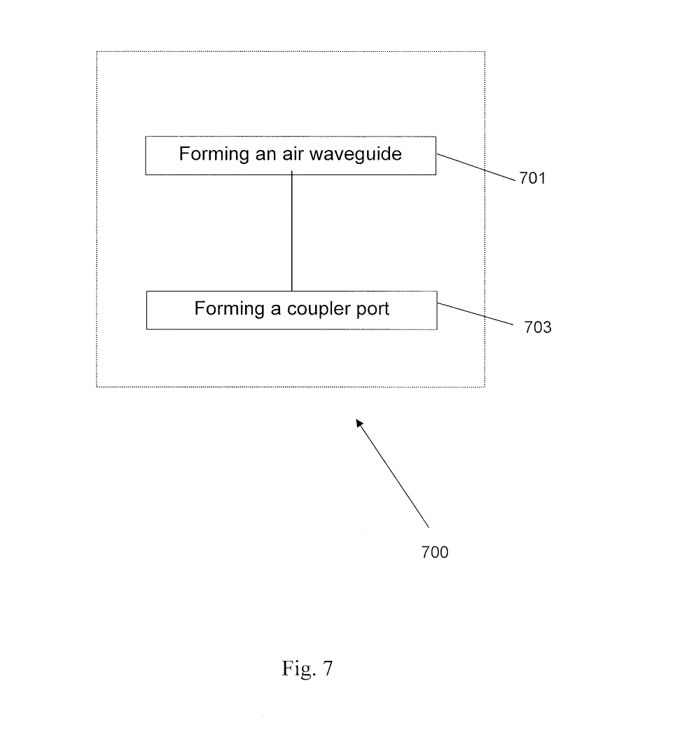

FIG. 7 shows a schematic diagram of a method 700 for producing a directional coupler arrangement according to an implementation form. The method 700 comprises: forming 701 an air waveguide 101; and forming 703 a coupler port 103 having a coupler line 105; wherein the coupler line 105 is arranged inside the air waveguide 101. In an implementation form, the forming 703 the coupler port 103 comprises forming the coupler line 105 as a microstrip line 107a, 107b, 107c; and placing the coupler line 105 unshielded inside the air waveguide 101 without touching a coating 109 of the air waveguide 101. In an implementation form, the method 700 further comprises forming a second coupler port 111 having a second coupler line 113. In an implementation form, the forming the second coupler port 111 comprises forming the second coupler line 113 as a second microstrip line 115a, 115b, 115c, 115d having a pitch 115a; and arranging the pitch 115a inside the air waveguide 101. In an implementation form, the method 700 further comprises forming the coupler line 105 and the pitch 115a on a substrate layer 123; and arranging the substrate layer 123 inside the air waveguide 101.

Many alternatives, modifications, and variations will be apparent to those skilled in the art in light of the above teachings. Of course, those skilled in the art will readily recognize that there are numerous applications of the invention beyond those described herein. While the present inventions has been described with reference to one or more particular embodiments, those skilled in the art will recognize that many changes may be made thereto without departing from the spirit and scope of the present invention. It is therefore to be understood that within the scope of the appended claims and their equivalents, the inventions may be practiced otherwise than as specifically described herein.

1. A directional coupler arrangement, comprising:
an air waveguide; and
a coupler port having a coupler line; wherein the coupler line is arranged inside the air waveguide.

2. The directional coupler arrangement of claim 1, wherein the coupler line comprises a microstrip line.

3. The directional coupler arrangement of claim 1, wherein the coupler line is unshielded and placed inside the air waveguide without touching a coating of the air waveguide.

4. The directional coupler arrangement of claim 1, further comprising
a second coupler port having a second coupler line.

5. The directional coupler arrangement of claim 4, wherein the second coupler line comprises a second microstrip line.

6. The directional coupler arrangement of claim 5, wherein the second microstrip line comprises a pitch arranged inside the air waveguide.

7. The directional coupler arrangement of claim 6, wherein the pitch is rectangular and a width of the coupler line is smaller than a width of the pitch.

8. The directional coupler arrangement of claim 1, further comprising:
an isolated port connected to the coupler line.

9. The directional coupler arrangement of claim 4, wherein the coupler line and the second coupler line are arranged on a common plane substantially perpendicular to a main direction of the air waveguide.

10. The directional coupler arrangement of claim 9, wherein the coupler line is U-shaped on the common plane.

11. The directional coupler arrangement of claim 9, wherein the coupler line is L-shaped on the common plane.

12. The directional coupler arrangement of claim 9, wherein the coupler line is I-shaped on the common plane.

13. The directional coupler arrangement of claim 9, wherein the coupler line and the second coupler line are arranged on a substrate layer forming the common plane.

14. A method of producing a directional coupler arrangement, comprising:
forming an air waveguide; and
forming a coupler port having a coupler line; wherein the coupler line is arranged inside the air waveguide.

15. The method of claim 14, wherein the forming the coupler port comprises:
forming the coupler line as a microstrip line; and
placing the coupler line unshielded inside the air waveguide without touching a coating of the air waveguide.

16. The method of claim 14, further comprising:
forming a second coupler port having a second coupler line.

17. The method of claim 16, wherein the forming the second coupler port comprises:
forming the second coupler line as a second microstrip line having a pitch; and
arranging the pitch inside the air waveguide.

18. The method of claim 17, further comprising:
forming the coupler line and the pitch on a substrate layer; and
arranging the substrate layer inside the air waveguide.
